(19) United States
(12) Patent Application Publication
(10) Pub. No.: US 2016/0001926 A1
(43) Pub. Date: Jan. 7, 2016

(54) Non-Slip Grip for Spray or Dispenser Bottles

(71) Applicant: Silvia Bui, Bologna (IT)

(72) Inventor: Silvia Bui, Bologna (IT)

(21) Appl. No.: 14/759,862

(22) PCT Filed: Aug. 1, 2013
(86) PCT No.: PCT/IB2013/001688

§ 371 Date: Jul. 8, 2015

(30) Foreign Application Priority Data
Jan. 9, 2013 (IT) CZ2013A000001

(51) Int. Cl. B65D 23/08; B05B 15/06; B05B 11/00

(52) U.S. Cl. CPC B65D 23/0892; B05B 11/0037; B05B 15/06

(57) ABSTRACT

Non-slip grip (100; 200; 300; 400) for spray or dispenser bottle (50) containing a cosmetic product comprising:
a base (101; 201; 301; 401) able to support the base of the bottle (50); and
first and second lateral rigid elements (102; 202; 302; 402) vertically extending from the base (101; 201; 301; 401) up at least to the neck of the bottle (50).

The non-slip grip (100; 200; 300; 400) for spray or dispenser bottle (50) further comprises, at a fixed height comprised between the base (101; 201; 301; 402) and terminal curved portions (102a; 202a; 302a; 402a) of the lateral rigid elements (102; 202; 302; 402), at least a pair of longitudinal elastic bands (103; 203; 303; 403a, 403b) each positioned between and connected to the rigid elements (102; 202; 302; 402), so as to firmly surround the bottle (50).

The present invention relates to a non-slip grip for spray or dispenser bottles.

As is known, to easily use bottles used for drinking, for example, during hiking, or bottles containing compressed air, different types of non-slip grips are added to the bottles. These non-slip grips are wrapped and closed around the bottles using velcro straps comprised in the grips.

Non-slip grips are also used to handle baby bottles suitable for babies and children, can be made of plastic or rubber and are designed to be ergonomic and to be easily managed by the children themselves. Normally, the rubber grips entirely surround the bottles and can have different shapes and colors.

However, in the field of cosmetics there are no solutions relating to non-slip grips for bottles, in particular for spray and dispenser bottles. In fact, the cosmetic bottles containing oily products or lotion, such as hair oil or scented oil/lotion for the body, have a completely smooth external and no anatomical shaped structure so that it's not easy to firmly grip the bottle and spray if having greasy hands due to the previous use and spray of the bottle. In fact, after a first delivery of the product contained in the bottle the user hands become soaked with oily product and the bottle results very slippery. Therefore, it is somewhat difficult to handle the bottle for the subsequent dispensing of the product.

Aim of the present invention is to provide non-slip grips for spray or dispenser bottles, which allows the use of the bottle without any effort especially avoiding the bottle sliding from wet or oily hands.

According to the present invention, a non-slip grip for spray or dispenser bottles is realized, as defined in claim 1.

For a better understanding of the present invention a preferred embodiment is described, by way of non limitative example, referring to the accompanying drawings, in which:

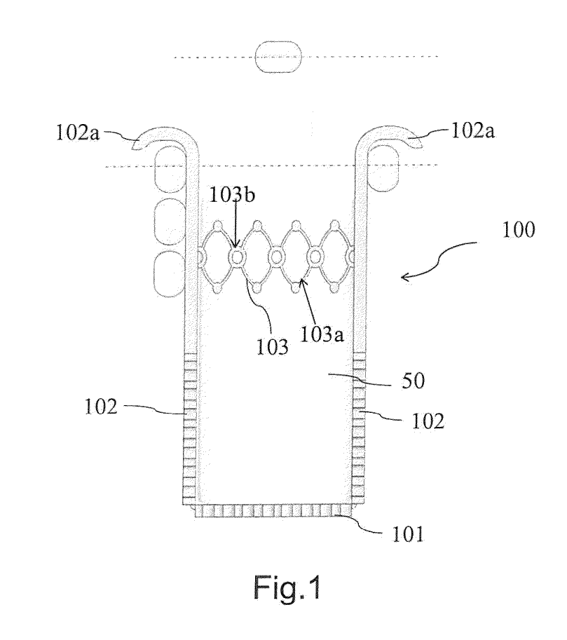

FIG. 1 shows a schematic three-dimensional view of a first embodiment of a non-slip grip for spray or dispenser bottles, according to the invention;

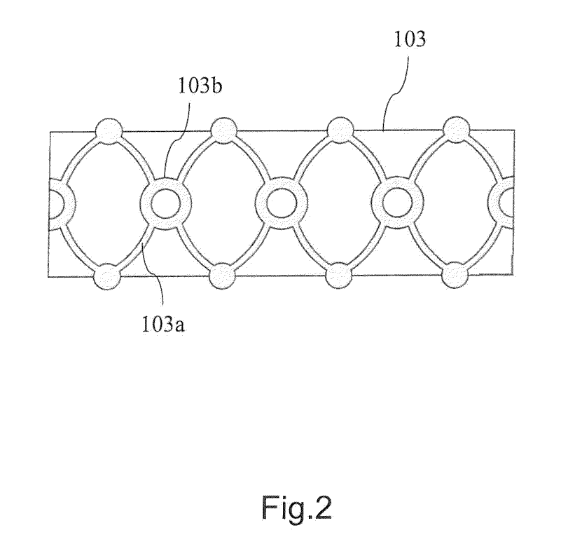

FIG. 2 shows a schematic front view of a side of the non-slip grip for spray or dispenser bottles, according to the invention;

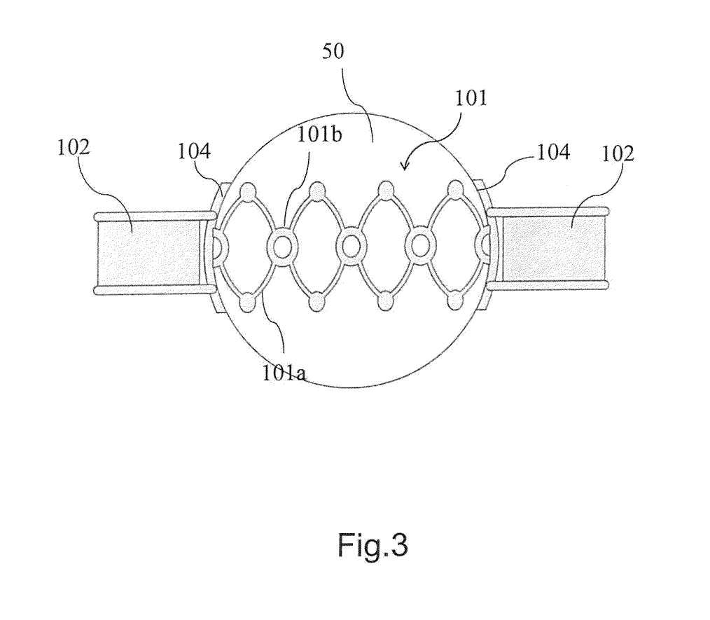

FIG. 3 shows a schematic bottom view of the non-slip grip for spray or dispenser bottles, according to the invention;

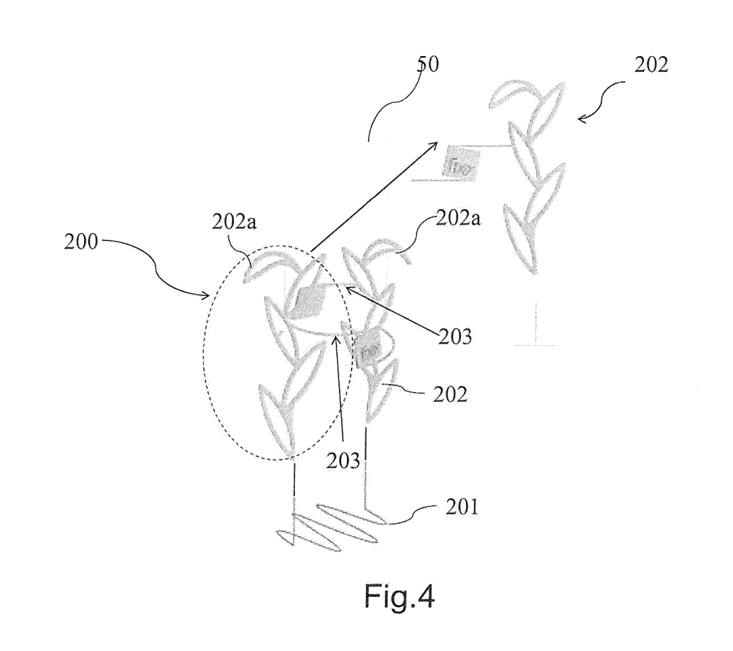

FIG. 4 shows a schematic three-dimensional view of a second embodiment of the non-slip grip slip for spray or dispenser bottles, according to the invention;

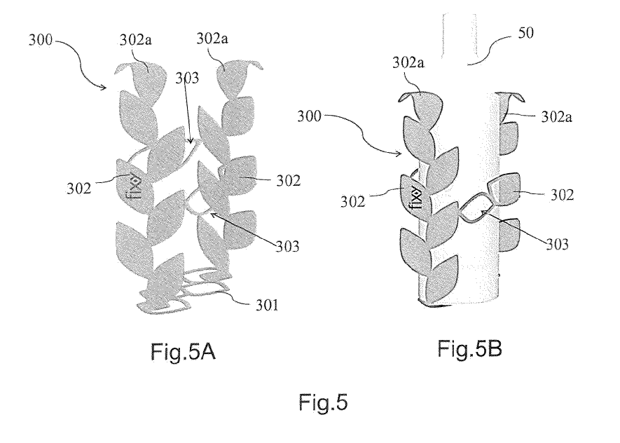

FIGS. 5A-5B show schematic three-dimensional views, respectively without and with the bottle inside, of a third embodiment of the non-slip grip for spray or dispenser bottles, according to the invention;

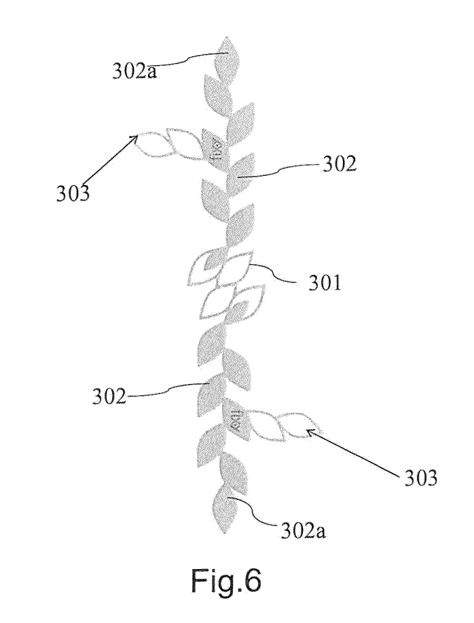

FIG. 6 shows a schematic two-dimensional view of the third embodiment of the non-slip grip for spray or dispenser bottles, according to the invention;

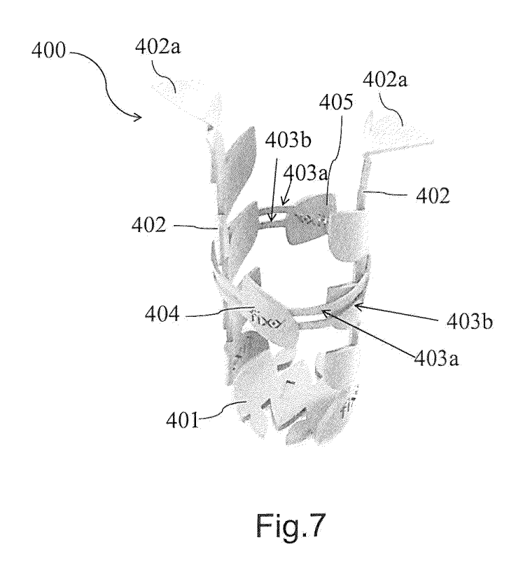

FIG. 7 shows a schematic three-dimensional view of a fourth embodiment of the non-slip grip slip for spray or dispenser bottles, according to the invention;

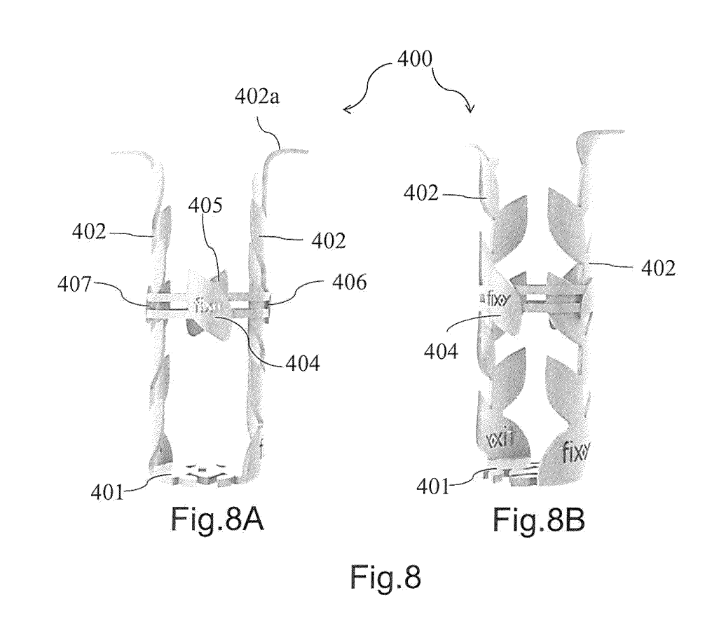

FIGS. 8A-8B show schematic three-dimensional lateral views of the fourth embodiment of the non-slip grip for spray or dispenser bottles, according to the invention;

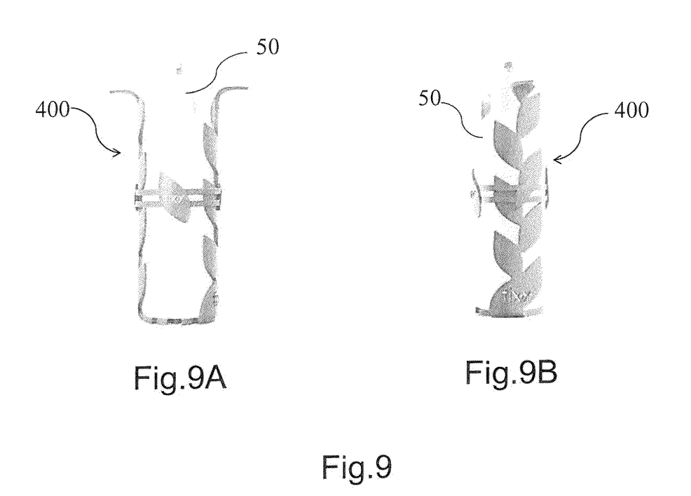

FIGS. 9A-9B show schematic three-dimensional lateral views, with the bottle inside, of the fourth embodiment of the non-slip grip for spray or dispenser bottles, according to the invention.

Referring to those figures, and in particular to FIG. 1, a non-slip grip 100 for spray or dispenser bottles is shown, according to a first embodiment of the invention. In more details, the FIG. 1 shows a bottle 50 containing a cosmetic product, the bottle having the non-slip grip 100 wrapped around it. The non-slip grip 100 comprises a base 101 for supporting the base of the bottle 50, and two rigid elements 102 laterally extending from the base 101 up to the neck of the bottle 50. These rigid elements 102 act as lateral support for the bottle 50 and end with curved portions 102a able to allow a user to easily grip the bottle 50 using only the fingers of a hand to easily push the spray or dispenser bottle. The non-slip grip 100 also comprises a first and a second elastic band 103 for longitudinal connection between the rigid elements 102, the elastic bands 102 and 103 being configured to wrap the bottle 50 and firmly keep the bottle 50 inside the non-slip grip 100.

According to an aspect of the invention, the rigid elements 102 are two shafts.

The FIG. 2 shows one of the elastic bands 103 more in details.

According to an aspect of the invention, each elastic band 103 is an elastic net having changeable shape and design. As an example, as shown in the FIG. 2, each elastic band 103 comprises an elastic net formed by a first series of large rings 103a concatenated each other via a second series of small rings 103b. The first and the last small ring 103b are used to connect the elastic band 103 to the rigid elements 102.

According to an aspect of the invention, the base 101 is a third elastic band comprising an elastic net having changeable shape and design. As an example, as shown in the FIG. 3, the base 101 comprises an elastic net formed by a first series of large rings 101a concatenated each other via a second series of small rings 101b. The first and the last small ring 101b are used to connect the elastic net forming the base 101 to the rigid elements 102, trough curved rigid supports 104.

According to another aspect of the invention, the non-slip grip has a width adaptable to all types of spray or dispenser bottles.

According to another aspect of the invention, the non-slip grip has a height variable depending on the bottle's height, the bottle having a maximum capacity equal to 1 litre.

According to an aspect of the invention, the non-slip grip is made of plastic material.

According to another aspect of the invention, the non-slip grip is made of silicon.

According to an aspect of the invention, the non-slip grip is made of rubber.

Advantageously, according to the invention, the non-slip grip is adaptable to all types of bottles, for example cylindrical, parallelepiped or having an elliptic shape.

Advantageously, according to the invention, the non-slip grip allows the stability of the bottle 50 when it is resting on a planar surface.

Advantageously, according to the invention, the non-slip grip may be a design object.

In particular, the FIG. 4 shows a second embodiment of the invention. An non-slip grip 200 comprises a base 201 having a spring or sinusoid shape, laterally extending rigid elements 202 ending with curved portions 202a configured for allowing a user to easily grip the bottle 50 using only the fingers of a hand. Moreover, the non-slip grip 200 comprises two elastic bands 203 consisting of semicircles elastic elements interconnecting the rigid elements 202 so as to longitudinally surround the bottle 50, as shown in the FIG. 4.

According to an aspect of the invention, the rigid elements 202 comprise multiple concatenated elements leaf shaped.

According to another aspect of the invention, the leaves of the non-slip grip 200 are internally hollow.

According to another aspect of the invention, the leaves of the non-slip grip 200 are internally full.

The FIG. 5 shows a third embodiment of the non-slip grip according to the invention. More in details, the FIGS. 5A and 5B show a non-slip grip 300, respectively with no bottle inserted and with the bottle 50 inserted. The non-slip grip 300 comprises a base 301 made from a sequence of internally hollow leaves, laterally extending rigid elements 302 made from a sequence of internally full leaves and ending with curved portions 302a for facilitating the grip with the fingers of the hand.

Moreover, the non-slip grip 300 comprises two longitudinal elastic bands 303 formed by a sequence of internally hollow leaves interconnecting the rigid elements 302 so as to surround the bottle 50.

The FIG. 6 shows a bi-dimensional view of the unfolded non-slip grip 300.

The FIG. 7 shows a fourth embodiment of the non-slip grip according to the invention. More in details, the FIG. 7 shows a non-slip grip 400 comprising a circular base 401 comprising a sequence of internally full leaves, laterally extending rigid elements 402 made from a sequence of internally full leaves and ending with curved portions 402a for facilitating the grip with the fingers of the hand. Moreover, the non-slip grip 400 comprises two circular parallel elastic bands 403a and 403b joined together via a first pair of opposite internally full leaves 404 and 405 and a second pair of opposite leaves 406 and 407, as shown in the FIG. 8. The bands 403a and 403b surround and interconnect the rigid elements 402 so as to form a sort of circle for containing the bottle 50, as shown in the FIG. 9.

Therefore, the non-slip grip for spray bottles according to the invention allows to firmly grip and use spray bottles avoiding the spray bottles sliding when the user's hands are wet or oily.

Another advantage of the non-slip grip for spray bottles according to the invention consists in the fact that the user can keep the bottle and spray the product with no effort.

Another advantage of the non-slip grip for spray bottles according to the invention is that it is adaptable to all types of bottles.

At the end, the non-slip grip for spray bottles according to the invention is low cost.

It should be clear that other modifications and embodiments carried out to the described non-slip grip can be done falling within the scope of the present invention, as defined in the appended claims.

1. An apparatus comprising:
a base element configured to support a bottle base; and
first and second lateral rigid elements vertically extending from the base element to substantially the neck of the bottle; and
at least a one pair of longitudinal elastic bands each positioned between and connected to the first and second lateral rigid elements.

2. The apparatus of claim 1, wherein the longitudinal elastic bands comprise an adjustable net.

3. The apparatus of claim 2, wherein the adjustable net comprises a first series of large rings linked together by a second series of small rings, a first and a last ring of the second series of small rings connected respectively to the first and to the second lateral rigid elements.

4. The apparatus of claim 1, wherein the bottle base comprises a third elastic band comprising an adjustable base net.

5. The apparatus of claim 4, wherein the base net comprises a first series of large base rings linked together by a second series of small base rings, the a first and a last small base ring connected respectively to the first and to the second lateral rigid elements by curved rigid supports.

6. The apparatus of claim 1, wherein the first and second lateral rigid elements comprise two shafts.

7. The apparatus of claim 1, wherein the longitudinal elastic bands comprise semicircle elastic elements.

8. The apparatus of claim 1, wherein the base element comprises an elastic net shaped as a spring or a sinusoid.

9. The apparatus of claim 1, wherein the first and second lateral rigid elements comprise multiple concatenated leaf shaped elements.

10. The apparatus of claim 1, wherein the longitudinal elastic bands comprise at least a sequence of internally hollow leaves.

11. The apparatus of claim 1, wherein the base element comprises at least one sequence of internally hollow leaves.

12. The apparatus of claim 1, wherein the first and second lateral rigid elements comprise at least a sequence of internally full leaves.

13. The apparatus of claim 1, wherein the elastic bands comprise two circular elastic parallel bands joined together a first pair of opposite internally full leaves and a second pair of opposite leaves.

14. The apparatus of claim 1, wherein the base element comprises is a circular base comprising a sequence of internally full leaves.

15. The apparatus of claim 1, wherein the first and second lateral rigid elements comprise a sequence of internally full leaves.

16-19. (canceled)

20. The apparatus of claim 1, wherein at least one of the first and second lateral rigid elements comprises an upper support extending outward from the lateral rigid element.

21. The apparatus of claim 20, wherein the upper support comprises a curved shape.

22. A method comprising:
providing a base element configured to support a bottle base;
providing first and second lateral rigid elements extending from the base element to substantially the neck of the bottle; and
providing at least one pair of longitudinal elastic bands positioned between and connected to the first and second lateral rigid elements.

23. The method of claim 22, wherein the at least one pair of longitudinal elastic bands comprises an adjustable net

24. The method of claim 22, wherein the bottle base comprises a third elastic band comprising an adjustable base net.
